(19) United States
(12) Patent Application Publication
(10) Pub. No.: US 2025/0305930 A1
(43) Pub. Date: Oct. 2, 2025

(54) PORE DEVICE

(71) Applicant: ADVANTEST CORPORATION, Tokyo (JP)

(72) Inventor: Hoshito TAGUCHI, Tokyo (JP)

(21) Appl. No.: 19/098,067

(22) Filed: Apr. 2, 2025

(30) Foreign Application Priority Data
Apr. 2, 2024 (JP) 2024-059648

(51) Int. Cl. G01N 15/13; G01N 15/12

(52) U.S. Cl. CPC G01N 15/13; G01N 2015/135

(57) ABSTRACT

A pore device can accommodate a pore chip. A body has the internal space partitioned by the pore chip into a first chamber and a second chamber. A substrate is connected to the body and has formed thereon electrodes which are at least partially exposed to the internal space of the body. Each of the electrodes has a first metal layer formed on the substrate; and a carbon barrier layer formed in a layer above the first metal layer, in a part exposed to the internal space of the body.

### REFERENCE TO RELATED APPLICATIONS

The present invention claims priority under 35 U.S.C. § 119 to Japanese Patent Application No. 2024-059648 filed on Apr. 2, 2024, the entire contents of which are incorporated herein by reference.

### BACKGROUND

### 1. Technical Field

The present disclosure relates to a pore device.

### 2. Description of the Related Art

Method for measuring particle size distribution called electrical sensing zone method (based on the Coulter's principle) has been known. In this measurement method, an electrolyte solution that contains a particle is allowed to pass through a pore called nanopore. During passage of the particle through the pore, the electrolyte solution in the pore will decrease the volume by an amount equivalent to the volume of the particle, thus increasing electric resistance of the pore. The volume (or, particle size) of the particle can therefore be determined, by measuring the electric resistance of the pore.

FIG. 1 is a block diagram illustrating a microparticle measurement system 1R making use of the electrical sensing zone method. A microparticle measurement system 1R has a pore device 100R, a measuring instrument 200R, and a data processor 300.

The inside of the pore device 100R is filled with an electrolyte solution 2 that contains particles 4 to be detected. The inside of the pore device 100R is partitioned by a pore chip 102 into two spaces, in which an electrode 106 and an electrode 108 are individually provided. Under potential difference generated between the electrode 106 and the electrode 108, an ion current flows between the electrodes, during which the particles 4 migrate from one space through the pore 104 into the other space while driven by electrophoresis.

The measuring instrument 200R generates the potential difference between the pair of the electrodes 106, 108, and acquires information correlated with resistivity Rp between the electrode pair. The measuring instrument 200R has a transimpedance amplifier 210, a voltage source 220, and a digitizer 230. The voltage source 220 is structured to generate a potential difference Vb between the pair of electrodes 106, 108. The potential difference Vb provides a driving force of electrophoresis, as well as a bias signal for measuring the resistivity Rp.

Between the pair of electrodes 106, 108, there flows microcurrent Is which is inversely proportional to the resistivity of the pore 104.

$$I s = Vb / Rp \qquad ( 1 )$$

The transimpedance amplifier 210 is structured to convert the microcurrent Is into a voltage signal Vs. Given a conversion gain as r, an equation below holds.

$$Vs = - r \times Is \qquad ( 2 )$$

Substitution of equation (1) into the equation (2) gives equation (3) below.

$$Vs = - V b \times r / Rp \qquad ( 3 )$$

The digitizer 230 is structured to convert the voltage signal Vs into digital data Ds. In this way, the voltage signal Vs inversely proportional to the resistivity Rp of the pore 104 is obtainable, with use of the measuring instrument 200R.

FIG. 2 is an exemplary waveform chart of the microcurrent Is measured by the measuring instrument 200R. Note that the ordinates and abscissae of the waveform charts or time charts referred to herein are appropriately enlarged or shrunk for easy understanding, and also the waveforms illustrated herein are simplified, exaggerated or emphasized for easy understanding.

For a short period of passage of the particles, the resistivity Rp of the pore 104 increases. The current Is therefore decreases in a pulsated manner; every time one particle passes. Amplitude of each pulse current correlates with the particle size. The data processor 300 is structured to process the digital data Ds, and to typically analyze the count or particle size of the particles 4 contained in the electrolyte solution 2. A part of the data processor 300 may be placed in a server or a cloud.
Patent Literature 1: JP 2023-2249 A
Patent Literature 2: WO2021-152954A1
Patent Literature 3: US 2015/0160160 A

FIG. 3 is a diagram illustrating a cross-sectional view of a pore device 100R examined by the present inventor. The pore device 100R has a substrate 110 and a body 120. The body 120 has two spaces 122, 124 partitioned by the pore chip 102. During the measurement, the spaces 122, 124 are filled with the electrolyte solution 2 that contains the particles 4.

The body 120 is provided on the substrate 110. The substrate 110 has, formed thereon, interconnects 112P, 112N that correspond to the electrodes 106, 108, respectively. Each of the interconnects 112P, 112N is drawn out from the inside of the spaces 122, 124 of the body 120, allowed for an ion exchange reaction with the electrolyte solution 2 in an ion exchange region 118 inside the body 120, and is electrically connectable to the measuring instrument 200 in an external contact region 116.

### SUMMARY

The present inventor examined the pore device 100R illustrated in FIG. 3, to recognize issues below.

For the substrate 110, candidates listed herein include film substrate of polyethylene terephthalate (PET) or the like, printed circuit board, and glass substrate.

The PET substrate is often used for the single-use (disposable) pore device 100R, for its inexpensiveness and high workability. On the PET substrate, which is however less heat-resistant, the interconnects 112P, 112N are often formed with use of silver particles allowed for low temperature forming.

Silver is, however, rapidly oxidized, and will have an insulating silver oxide film formed on the surface thereof. The insulating film prevents electrical connection with the substrate 110, in the contact region 116. Electrical connection with the silver interconnect, if tried typically with use of a pogo pin, may be established after breaking the insulating silver oxide film by wiping to create a newly exposed surface. The contact, however, tends to be destabilized due to thinness of the silver interconnects.

The printed circuit board is usually used in electrode formation, which is formed of a glass-epoxy material typically in a class of flame retardant type 4 (FR-4). On the printed circuit board, the interconnect layer is formed of copper and is typically plated with gold, so that the interconnects will be free from risk of oxidation unlike on the PET substrate and can keep good contact with the external electrodes.

However, considering the use as the substrate 110 of the pore device 100R while filing up the inside of the body 120 with the electrolyte solution 2, chloride ions contained in the electrolyte solution 2 would permeate through the silver/silver chloride electrodes and the underlying gold plating, to reach the interconnects made of copper. This would chlorinate the copper, thus allowing insulating copper chloride to deposit on the surface of the electrodes, whereby contact failure would occur.

The glass substrate is often used in electrochemical measurement with use of an electrolyte solution. Glass, whose melting point is high, is allowed for direct formation of gold interconnect by vapor deposition. Glass has therefore a low risk of chlorination concerned on the printed circuit board, or contact failure concerned on the PET substrate. Glass however costs one digit or more higher and is not suitable for the disposable pore device.

The present disclosure has been arrived at considering such circumstances, and one exemplary embodiment thereof is to provide a highly reliable pore device.

One embodiment of the present disclosure relates to a pore device. The pore device includes a body having an internal space including a first chamber and a second chamber that communicate through a pore and being structured to be filled with an electrolyte solution; and a substrate connected to the body, and having formed thereon electrodes which are at least partially exposed to the internal space of the body. Each of the electrodes includes: a first metal layer formed on the substrate; and a carbon barrier layer formed in a layer above the first metal layer, in a part exposed to the internal space of the body.

It is to be noted that any arbitrary combination or rearrangement of the above-described structural components and so forth is effective as and encompassed by the present embodiments. Moreover, all of the features described in this summary are not necessarily required by embodiments so that the embodiment may also be a sub-combination of these described features. In addition, embodiments may have other features not described above.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a microparticle measurement system making use of the electrical sensing zone method;

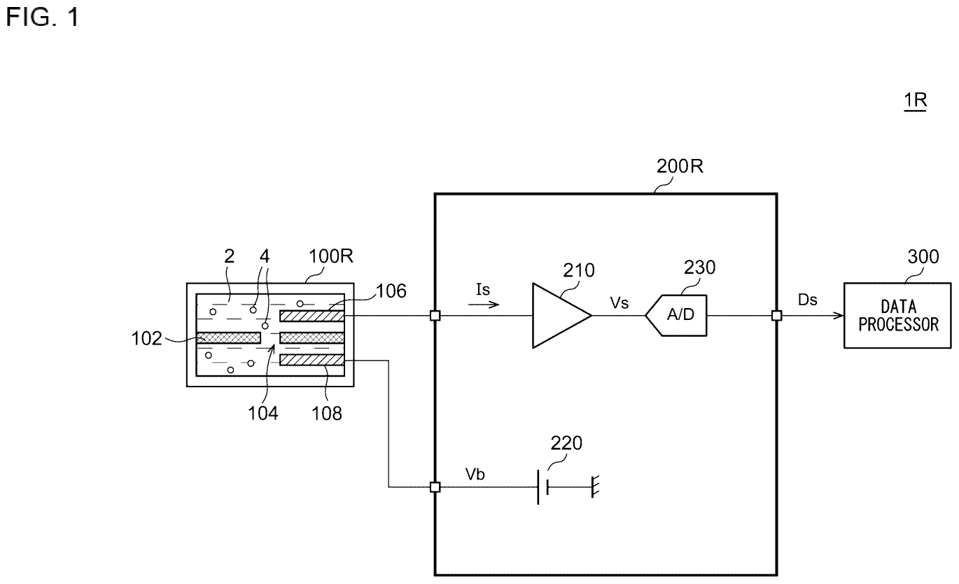

FIG. 2 is an exemplary waveform chart of microcurrent Is measured with a measuring instrument;

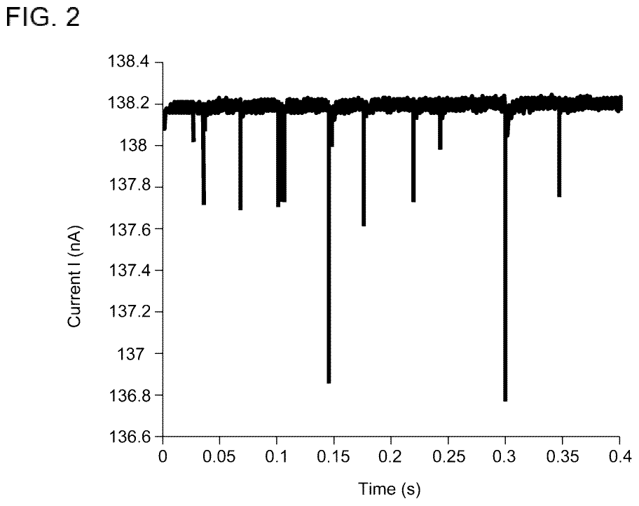

FIG. 3 is a cross-sectional view of a pore device examined by the present discloser;

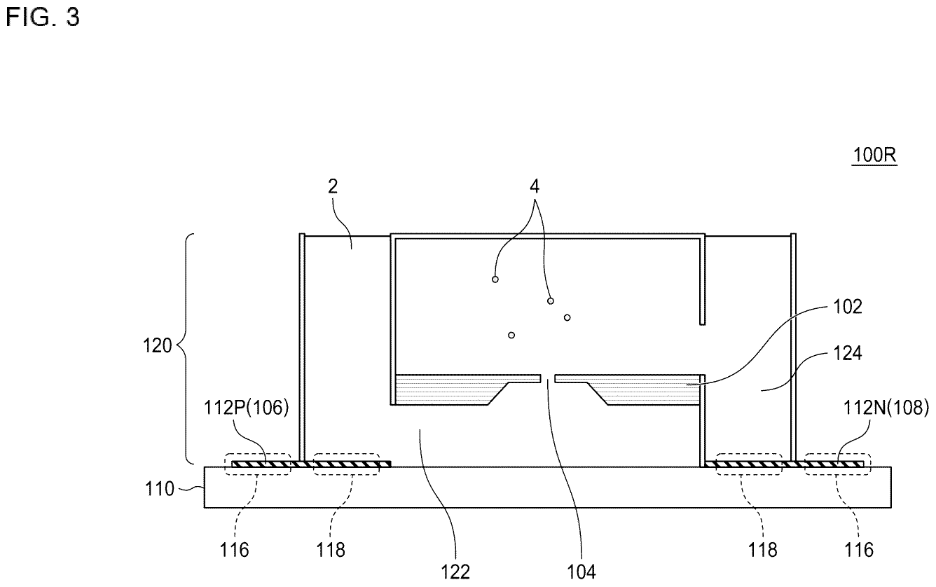

FIG. 4 is a cross-sectional view of a pore device according to Embodiment 1;

FIG. 5 is a drawing illustrating a result of surface component analysis of an electrode part of a comparative sample manufactured without forming a carbon barrier layer;

FIG. 6 is a drawing illustrating a result of surface component analysis of an electrode part of a sample having a carbon barrier layer;

FIG. 7 is a cross-sectional view of a pore device according to Embodiment 2;

FIG. 8 is a cross-sectional view of a pore device according to Modified Example 1; and

FIG. 9 is a cross-sectional view of a pore device according to Modified Example 2.

### DETAILED DESCRIPTION

### Outline of Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A pore device according to one embodiment includes: a body having an internal space including a first chamber and a second chamber that communicate through a pore and being structured to be filled with an electrolyte solution; and a substrate connected to the body, and having formed thereon electrodes which are at least partially exposed to the internal space of the body. Each of the electrodes includes: a first metal layer formed on the substrate; and a carbon barrier layer formed in a layer above the first metal layer, in a part exposed to the internal space of the body.

This structure can block chloride ions contained in the electrolyte solution with use of the carbon barrier layer and can therefore prevent the chloride ions from reaching the first metal layer, thus improving the reliability.

In one embodiment, the substrate may be a printed circuit board, the material of the first metal layer may be Cu, and the electrodes may further include a second metal layer of Ni formed on the first metal layer, and a third metal layer of Au formed on the second metal layer. The carbon barrier layer may be formed on the third metal layer. This successfully prevent Cu from degrading.

In one embodiment, the substrate is a film substrate, and a material of the first metal layer may be Ag (silver). This successfully prevent Ag from being chlorinated.

In one embodiment, the carbon barrier layer may also be formed in a part exposed to an outer space of the body. This successfully prevents Ag from being oxidized.

In one embodiment, each electrode may further have an Ag/AgCl (silver/silver chloride) layer formed on the carbon barrier layer. This successfully allows the ion exchange with the electrolyte solution to proceed efficiently.

A microparticle measurement system according to one embodiment may have any one of the aforementioned pore devices; and a measuring instrument structured to apply an electrical signal to the electrodes of the pore device, and to measure an electrical signal generated in the pore device.

### Embodiments

Preferred embodiments will be explained below, referring to the attached drawings. All similar or equivalent constituents, members and processes illustrated in the individual drawings will be given same reference numerals, so as to properly avoid redundant explanations. The embodiments are merely illustrative and are not restrictive about the invention. All features and combinations thereof described in the embodiments are not always necessarily essential to the disclosure and invention.

Dimensions (thickness, length, width, etc.) of the individual members illustrated in the drawings may be appropriately enlarged or shrunk for easy understanding. Furthermore, the dimensions of the plurality of members do not necessarily indicate the dimensional relationship among them, so that a certain member A, if depicted thicker than another member B in a drawing, may even be thinner than the member B.

In the present specification, a “state in which a member A is coupled to a member B” includes a case where the member A and the member B are physically and directly coupled, and a case where the member A and the member B are indirectly coupled while placing in between some other member that does not substantially affect the electrically coupled state, or does not degrade the function or effect demonstrated by the coupling thereof.

Similarly, a “state in which a member C is provided between the member A and the member B” includes a case where the member A and the member C, or the member B and the member C are directly coupled, and a case where they are indirectly coupled, while placing in between some other member that does not substantially affect the electrically coupled state among the members, or does not degrade the function or effect demonstrated by the members.

In the present specification, reference signs attached to electric signals such as voltage signal and current signal, or circuit elements such as resistor, capacitor, and inductor represent voltage value, current value, or circuit constants (resistivity, capacitance, and inductance) of the individual components as necessary.

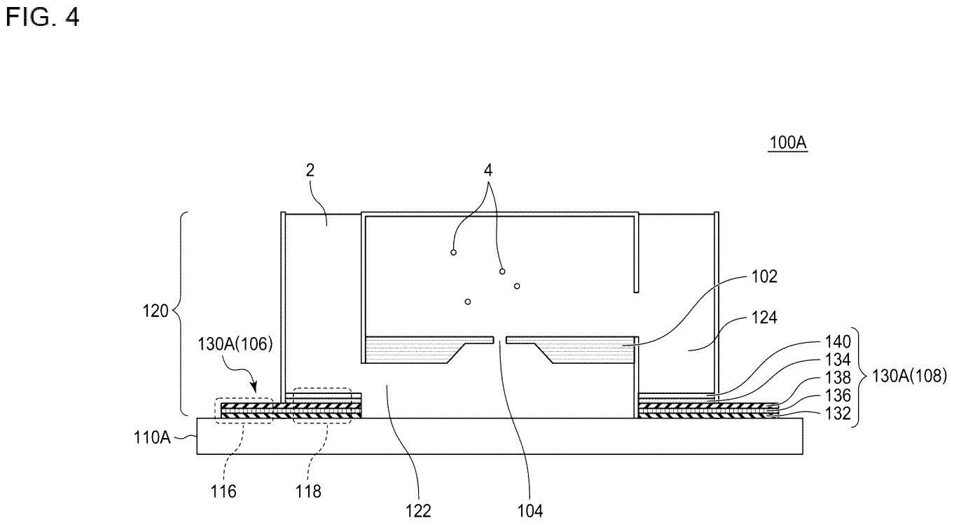

FIG. 4 is a cross-sectional view of a pore device 100A according to Embodiment 1. The pore device 100A has a printed circuit board 110A and a body 120.

The body 120 has an internal space that includes a first chamber (also referred to as a first flow path) 122 and a second chamber 124 that communicate through the pore. The body 120 is structured so that the internal space thereof can be filled with the electrolyte solution. In Embodiment 1, the body 120 includes the pore chip 102 having the pore formed therein, and a pore chip case that accommodates the pore chip 102. The internal space of the body 120 is partitioned into the first chamber 122 and the second chamber 124 by the pore chip 102.

The printed circuit board 110A is a glass-epoxy substrate typically of grade FR-4. The printed circuit board 110A is connected to body 120. The printed circuit board 110A has, formed thereon, a first electrode 106 at least partially exposed in the first chamber 122 which is the internal space of the body 120, and a second electrode 108 at least partially exposed in the second chamber 124 which is the internal space of the body 120.

The first electrode 106 and the second electrode 108 are interconnects 130A having the same interconnect structure.

Each interconnect 130A includes a first interconnect layer 132, a second interconnect layer 136, a third interconnect layer 138, a carbon barrier layer 134, and an Ag/AgCl layer 140, which are stacked in this order on a printed circuit board 110A. The first interconnect layer 132 is formed of Cu, the second interconnect layer 136 is formed of Ni, and the third interconnect layer 138 is formed of Au. The carbon barrier layer 134 is electro-conductive and is formed on the third interconnect layer 138. On the carbon barrier layer 134, and specifically on a part thereof (ion exchange region) exposed inside the body 120, there is formed the Ag/AgCl layer 140 intended for efficient ion exchange with the electrolyte solution 2.

The carbon barrier layer 134 preferably has a thickness of approximately 10 μm to 30 μm, which is specifically and preferably 20 μm or around. Within this range, chloride ions is successfully blocked, while suppressing the manufacturing cost from increasing.

A structure of the pore device 100A has been described. Next, the advantage will be explained. In order to verify the advantage of the carbon barrier layer 134 in the pore device 100A, a sample device illustrated in FIG. 4 having the carbon barrier layer, and a comparative sample device without the carbon barrier layer were manufactured. The two samples were then filled inside with the electrolyte solution and energized and then subjected to a surface component analysis of the electrodes.

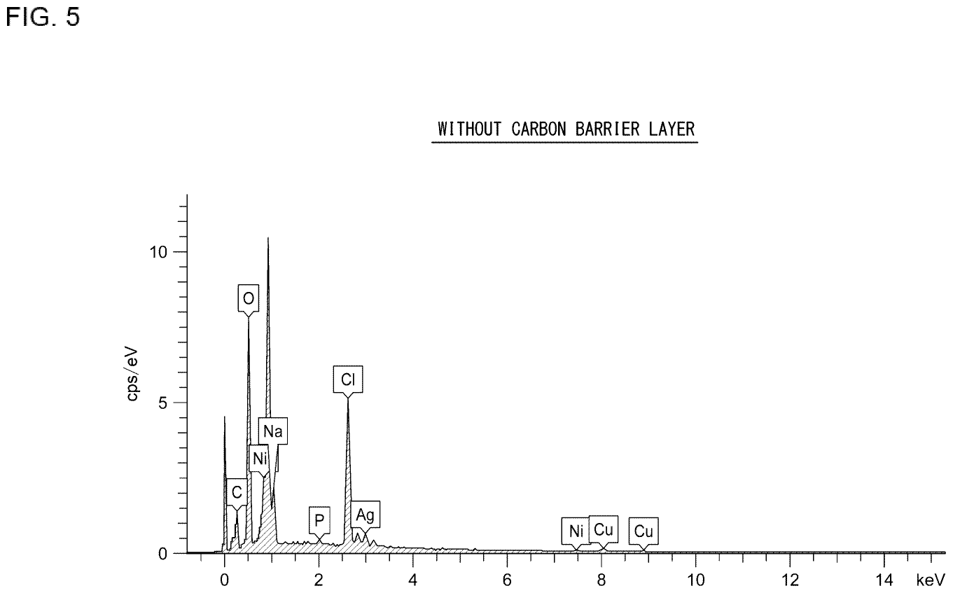

FIG. 5 is a drawing illustrating a result of the surface component analysis of an electrode part of a comparative sample manufactured without forming the carbon barrier layer. The sample manufactured without forming the carbon barrier layer was found to have much Cu and Cl detected on the surface of the electrodes.

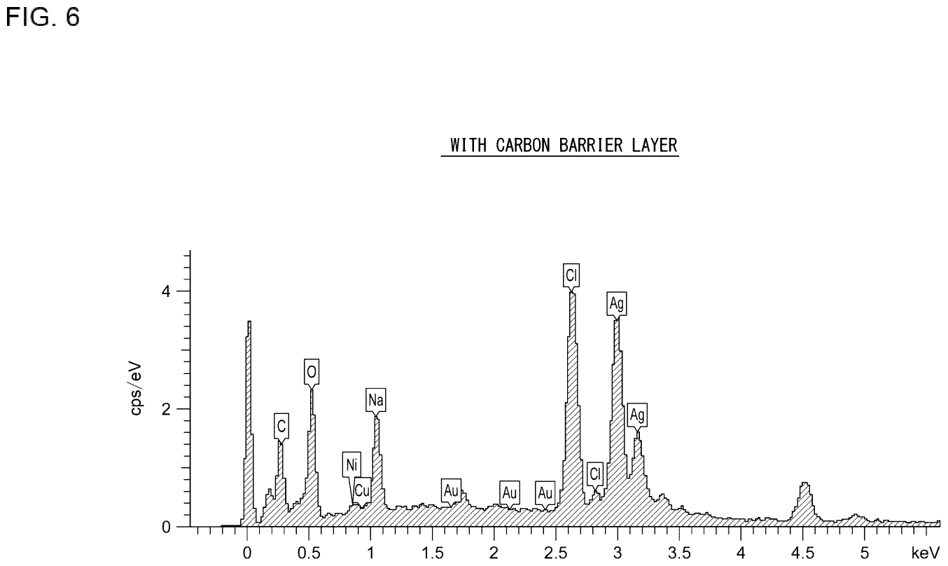

FIG. 6 is a drawing illustrating a result of the surface component analysis of an electrode part of the sample having the carbon barrier layer. The sample having the carbon barrier layer was found to have no Cu appeared on the surface, instead having much Ag contained in the Ag/AgCl layer 140 detected on the surface.

The pore device 100A illustrated in FIG. 4 can prevent chloride ions, having been contained in the electrolyte solution 2, from reaching the first interconnect layer 132. This makes it possible to prevent generation of copper chloride in the first interconnect layer 132, and deposition of copper chloride on the surface of the electrodes.

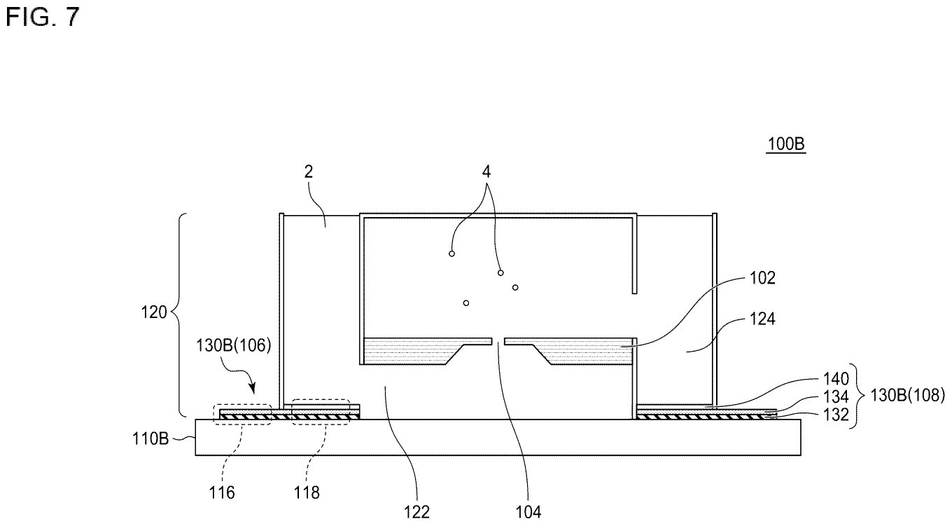

FIG. 7 is a cross-sectional view of a pore device 100B according to Embodiment 2. The pore device 100B according to Example 2 has a film substrate 110B, in place of the printed circuit board 110A. The film substrate 110B is typically formed of a PET substrate, on which the electrodes 106, 108 are formed. The electrodes 106, 108 are formed of interconnects 130B having the same structure. Material of the film substrate 110B is not limited to PET, instead allowing use of polyimide, cycloolefin polymer, acrylic resin or the like, for the manufacture.

Each interconnect 130B has the first interconnect layer 132, the carbon barrier layer 134, and the Ag/AgCl layer 140 which are stacked. The first interconnect layer 132 is formed of Ag. The carbon barrier layer 134 is formed on the first interconnect layer 132. The carbon barrier layer 134 is formed both inside and outside of the body 120.

The structure of the pore device 100B has been described. Inside the body 120 of the pore device 100B, the carbon barrier layer 134 can prevent the chloride ions in the electrolyte solution 2 from reaching the first interconnect layer 132.

Outside the body 120, the carbon barrier layer 134 can prevent the first interconnect layer 132 from being oxidized.

Next, modified examples of the interconnect 130 will be described.

### Modified Example 1

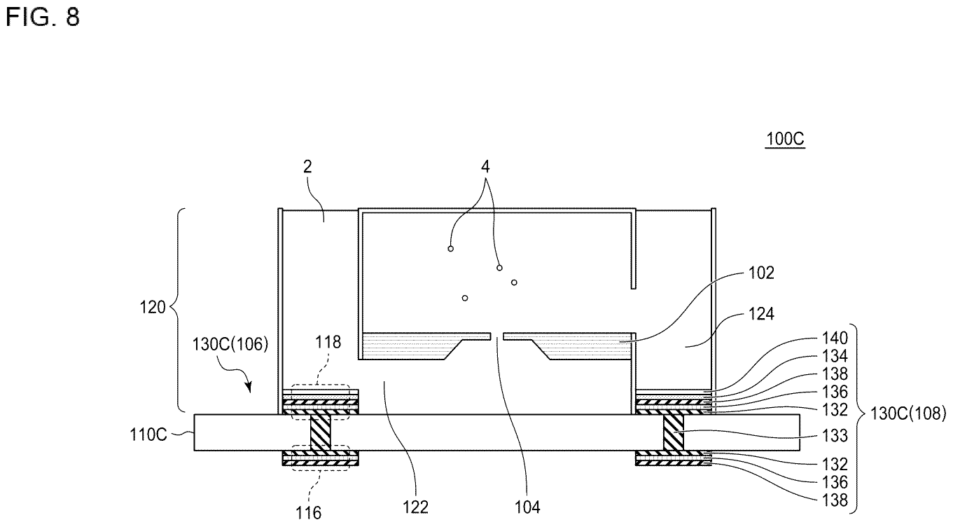

FIG. 8 is a cross-sectional view illustrating a pore device 100C according to Modified Example 1. The contact region, having been formed on the top face of the substrate 110 in Examples 1 and 2, is not necessarily limited thereto. The contact region 116 in Modified Example 1 is formed on the back face of the substrate 110C, that is, on the opposite side of the ion exchange region 118.

An interconnect 130C has an interconnect or a pad that contains the first interconnect layer 132, the carbon barrier layer 134, and the third interconnect layer 138 stacked on the back face of the substrate 110C. The first interconnect layer 132 on the top face of the substrate 110C and the first interconnect layer 132 on the back face are connected by a viahole 133.

### Modified Example 2

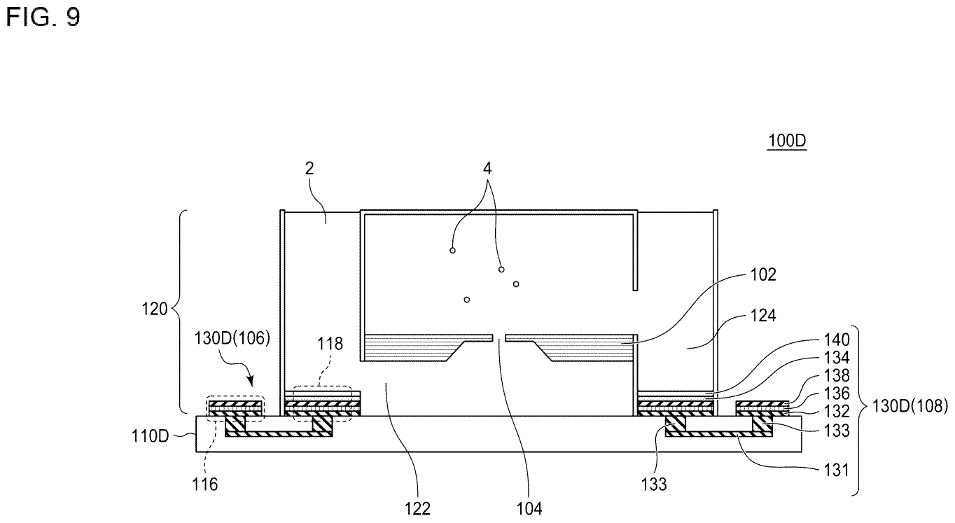

FIG. 9 is a cross-sectional view illustrating a pore device 100D of Modified Example 2. In Modified Example 2, the contact region 116 and the ion exchange region 118 are connected through an interconnect 131 and viaholes 133 both buried in a printed circuit board 110D.

### Modified Example 3

Although the body in the embodiments was constituted of a combination of the pore chip and the pore chip case, the present disclosure is not limited thereto. The first chamber, the second chamber, and the pore through which these spaces are communicated may be integrally formed in the body.

Having described the present disclosure with use of specific terms referring to the embodiments, the embodiments merely illustrate the principle and applications of the present disclosure, allowing a variety of modifications and layout change without departing from the spirit of the present disclosure specified by the claims.

What is claimed is:

1. A pore device comprising:
a body having an internal space including a first chamber and a second chamber that communicate through a pore, and being structured to be filled with an electrolyte solution; and
a substrate connected to the body, and having electrodes formed thereon, which are at least partially exposed to the internal space of the body, wherein
each of the electrodes comprises:
a first metal layer formed on the substrate; and
a carbon barrier layer formed on a layer above the first metal layer, in a part exposed to the internal space of the body.

2. The pore device according to claim 1, wherein
the substrate is a printed circuit board,
a material of the first metal layer is Cu,
the electrode further comprises:
a second metal layer of Ni formed on the first metal layer; and
a third metal layer of Au formed on the second metal layer; and
the carbon barrier layer is formed on the third metal layer.

3. The pore device according to claim 1, wherein
the substrate is a film substrate, and
a material of the first metal layer is Ag.

4. The pore device according to claim 3, wherein
the carbon barrier layer is also formed in a part exposed to an external space of the body.

5. The pore device according to claim 1, wherein the carbon barrier layer has a thickness of 10 μm to 30 μm.

6. The pore device according to claim 1, wherein
each of the electrodes further comprises an Ag/AgCl layer formed on the carbon barrier layer.

7. A microparticle measurement system comprising:
the pore device according to claim 1; and
a measuring instrument structured to apply an electrical signal to the electrodes of the pore device, and to measure an electrical signal generated in the pore device.
